(19) United States
(12) Patent Application Publication
(10) Pub. No.: US 2004/0027575 A1
(43) Pub. Date: Feb. 12, 2004

(54) Wavelength tuning control for multi-section diode lasers

(76) Inventors: William A. Von Drasek, Oak Forest, IL (US); Shawn D. Wehe, Shirley, MA (US); Mark G. Allen, Boston, MA (US)

Correspondence Address: Linda K. Russell, Esq., AIR LIQUIDE, Suite 1800, 2700 Post Oak Blvd., Houston, TX, 77056, US

(21) Appl. No.: 10/353,807

(22) Filed: Jan. 29, 2003

Related U.S. Application Data
(60) Provisional application No. 60/356,694, filed on Feb. 14, 2002.

(51) Int. Cl. G01N 21/00

(52) U.S. Cl. 356/432

(57) ABSTRACT

A method to provide user selected tunability for multi-section lasers manufactured for the telecommunication industry is disclosed. Extending the tunability of the laser to be user selectable provides a means to use the technology in other applications such as gas sensing or optical component testing. The combination of the broad tuning range with rapid wavelength selection will permit a reduction in the number of DFB lasers used in multiplexed systems thereby reducing system cost and complexity.

### CROSS REFERENCE TO RELATED APPLICATION

This application claims the benefit of U.S. Provisional Application No. 60/356,694, filed Feb. 14, 2002.

### BACKGROUND OF THE INVENTION

1. Field of the Invention

Semiconductor near-IR diode laser devices have found use in a variety of applications such as telecommunication, optical storage, positioning, and gas sensing. For single section, monolithic distributed feedback lasers, gross wavelength tuning is performed by temperature control and fine-tuning by injection current control. The limitation of the tuning range requires the use of multiplexed systems involving multiple lasers and controllers, adding cost and complexity to the system. The emergence of multi-section diode lasers centered on the ITU-GRID channel for telecommunication DWDM applications provides a means of accessing a broad wavelength range from a single device at tens of kHz rates. However, for applications requiring the laser to be tuned off the ITU-GRID channel, e.g., in gas sensing, a control circuit is required. A controller is disclosed utilizing on-board voltage to current converters, providing a means for high scan rates at selected wavelengths. The controller therefore has many applications in gas sensing and optical component testing.

2. Description of the Prior Art

The emergence of near-IR diode lasers from the telecommunication and optical storage industries has resulted in a supply of robust dependable devices that are cost effective when produced in high volume. The characteristics of these devices, i.e., near room temperature operation, single mode, wavelength tunable, and fiber optic compatible, has generated interest in other areas, such as gas sensing, motion control, etc. For gas sensing applications, the development of tunable diode lasers that can access absorption transitions of important chemical species such as CO, O₂, H₂O, CO₂, etc. has provided an alternative analytical measurement technique that has been demonstrated in both laboratory and industrial settings. The measurement is conducted by launching a beam of radiation across the process to a receiver that monitors the radiation intensity. By ramping the injection current to the device, the laser can be rapidly tuned across a resonance absorption transition of the targeted species to record the absorption spectrum that contains both the baseline and the absorption line feature. The Beer-Lambert relation describes the resulting absorption of the laser radiation along the measurement path for a single species given by:

Iᵥ=I_{v,o}e^{[-S(T)g(v-v}^{ₒ}^{)Nl]}

where Iᵥ is the laser intensity at frequency V measured after the beam has propagated across a path l with N absorbing molecules per volume. The incident laser intensity is I_{v,o} and is referred to as the reference. The amount of laser radiation attenuated is determined by the temperature dependent linestrength S(T) and the lineshape function g(v−vₒ). Inversion of Eq. 1 relates the number density N to the measured laser intensities and known linestrength and pathlength given by:

$$N = \frac{1}{S ( T ) l} \int ln ( \frac{{I}_{vo}}{{I}_{v}} ) ⅆ v$$

The rapid tunability of the diode laser, reported values up to 10,000 Hz, allows signal averaging of several hundreds of spectra over a short time interval (<1 sec). Allen, M. G., DIODE LASER ABSORPTION SENSORS FOR GAS-DYNAMIC AND COMBUSTION FLOWS, Measurement Science and Technology, Vol. 9, pg. 545-562 (1998). The fast time response of the technique provides essentially real-time process monitoring suitable for dynamic monitoring and control.

One drawback with DFB lasers is the narrow tuning range achievable through varying the injection current, typically 1-3 cm⁻¹, thereby limiting the number of species that can be monitored with a single laser. Extension of the tuning range over several nanometers can be obtained by varying the device temperature, but this method sacrifices the speed at which multiple spectral regions can be monitored due to the time required for the laser to become thermally stable. External cavity lasers such as those offered by New Focus (San Jose, Calif.) operate with a broader tuning range, e.g., model 6328 has tuning range of 1520-1570 nm with tuning speed of 10 nm/s, but sacrifice speed. Therefore, applications requiring multiple species monitoring, as required in high temperature processes where the temperature is not known or is varying, require several DFB lasers, as suggested by Frontini et al., to maintain a fast-response time.

Examples implementing multiple DFB lasers where both temperature and concentration are required are shown by Ebert, et al., SIMULTANEOUS DIODE-LASER-BASED IN SITU DETECTION OF MULTIPLE SPECIES AND TEMPERATURE IN GAS-FRIED POWER PLANT, Proceedings of the Combustion Institute, Vol. 28, pp. 423-430 (2000), work on a 1 GW gas-fired power plant monitoring, and Furlong, et al., DIODE-LASER SENSORS FOR REAL-TIME CONTROL OF TEMPERATURE AND H₂O IN PULSED COMBUSTION SYSTEMS, 34th AIAA/ASME/SAE/ASEE Joint Propulsion Conference, AIAA-98-3949 (1998), work on a pulsed waste incinerator. In both cases, the integration of multiple lasers into a system adds complexity to the system by requiring additional wavelength discriminating means for the different laser wavelengths.

An alternative approach to replace multiple DFB lasers was shown by Upschulte, et al., IN SITU MULTI-SPECIES COMBUSTION SENSOR USING A MULTI-SECTION DIODE LASER, 36th Aerospace Sciences Meeting & Exhibit, Reno, Nev., AIAA 98-0402 (1998). Demonstration of multi-species monitoring using a single four-section grating-coupled sampled reflector (GCR) device for simultaneous detection of CO, H₂O and OH in laboratory flame exhaust gases. The lasers fast scanning capability can access any wavelength within a 40 nm band in ˜1 μs. These tests on the early generation multi-section laser showed tuning range accessibility of tens of nm. This range is comparable to external cavity devices and far larger than any current DFB or VCSEL device.

Control of the laser tuning is conducted by varying the injection current in each section of the laser. The four-section GCSR laser is a monolithic InGaAsP laser that shares several similarities with Disturbed Bragg Reflector (DBR) lasers. However, unlike conventional DBR lasers, the sampled reflector grating incorporated in to the GCSR generates a comb of reflection peaks spaced at approximately 4 nm. The tunable coupler acts as a filter to select only one peak from the comb spectrum. By adjusting the current in the reflector changes the waveguide index for refraction, thus shifting the peak to shorter wavelengths. See FIG. A.

By selecting the proper current combinations for the reflector and coupler, wavelengths in the 1529-1561 nm spectral range are accessible. The tuning characteristics are shown in FIG. B for a constant gain current. See Fig. B.

The tunability features of the multi-section laser have attracted attention in the telecommunication industry for DWDM (Dense Wavelength Division Multiplexing) applications in line with ITU GRID (International Telecommunication Union). Manufacture of these devices, though still complex, has been refined; higher power outputs and suppliers now offer fiber optically coupled packaged systems. However, because these lasers are targeted for the telecommunication industry, user selected tunability, as needed for gas sensing applications, is not provided. User selected wavelengths are only those defined by the ITU-GRID channels.

Whereas the device used by Upschulte et al. was an early generation device that was not fiber coupled, each section of the laser was controlled by individual current controllers, allowing user selected wavelength control. This was adequate for laboratory demonstration of gas sensing applications, but not practical for industrial applications due to its lack of durability and adaptability under field conditions.

### SUMMARY OF THE INVENTION

A method to provide user selected tunability for multi-section lasers manufactured for the telecommunication industry is disclosed. Extending the tunability of the laser to be user selectable provides a means to use the technology in other applications such as gas sensing or optical component testing. The combination of the broad tuning range with rapid wavelength selection facilitates a reduction in the number of DFB lasers used in multiplexed systems, thereby reducing system cost and complexity.

### BRIEF DESCRIPTION OF THE DRAWINGS

In the detailed description that follows, reference will be made to the following figures:

FIG. A illustrates a schematic of a known GCSR multi-section laser;

FIG. B illustrates known wavelength range accessibility with selected tuning currents;

FIG. 1 illustrates a spectral/temporal relationship of a scan;

FIG. 2 illustrates tuning behavior of a DBR laser;

FIG. 3 is a schematic illustration of digital controls for use with a laser;

FIG. 4 is an illustration showing a preferred embodiment of DCDM; and

FIG. 5 is an illustration showing a preferred embodiment of DCAM.

### DETAILED DESCRIPTION OF PREFERRED EMBODIMENTS

The older generation multi-section laser as used by Upschulte, et al., supra, was similar to the ADC (ADC Worldwide Headquarters, 13,625 Technology Drive, Eden Prairie, Minn. 55344) NYW-35 product that has been made discontinued. Specifically, the NYW-35 provides direct current access to each section.

To overcome the laser control issues associated experienced with the NYW-35 package, ADC integrated the laser into a PC board featuring an 8-bit parallel interface for complete digital laser control (product name NYW-55). Through the exchange of digital arguments, section currents can be adjusted and read. Additionally, commands exist to control the laser temperature and monitor power. A separate serial interface (EVB) enables laser control via a standard RS-232 port, albeit at a slower data transfer rate.

Another feature of the NYW-55 package is an option to control the current to each of the sections through an analog voltage interface. The section currents can be modulated through voltages applied to input pins. On-board voltage-to-current converters regulate the current in proportion to applied voltage (0 to 3 V). The current controller's bandwidth is selectable to 4 MHz, however bandwidths less than 100 kHz are recommended to maintain a narrow spectral output.

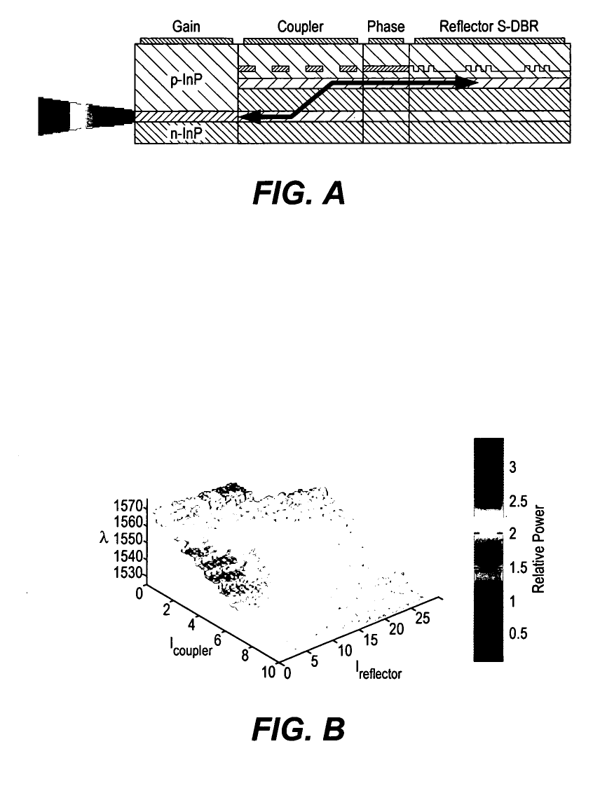

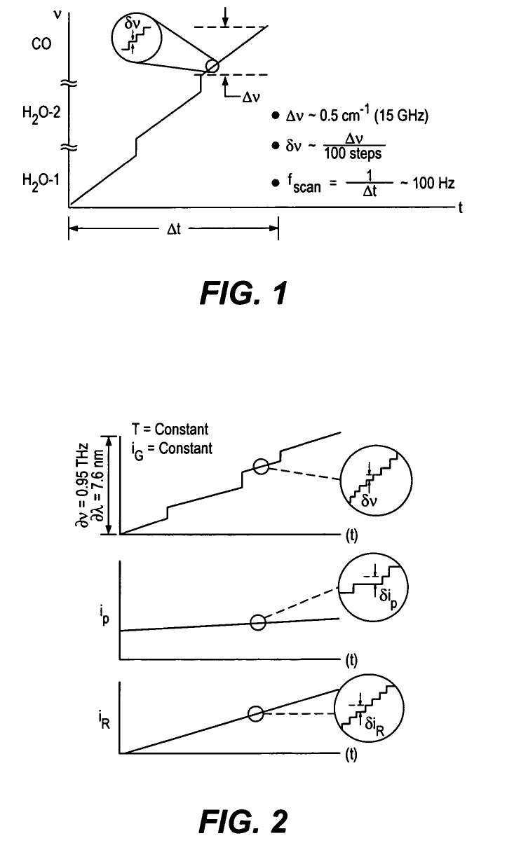

For gas sensing applications, it is desired to spectrally scan the laser across selected resonant transitions, e.g., water and carbon monoxide near 1.55 microns. FIG. 1 illustrates the spectral/temporal relationship of each scan. The goal is to sweep the laser (Δv) approximately 0.5 cm⁻¹ (15 GHz) across each transition. Each sweep would be composed of small spectral-frequency steps (δv) where δv is approximately 150 MHz. Ideally, the three sweeps would occur sequentially over a time interval of 10 ms to be repeated at 100 Hz.

The three-section DBR laser achieves a broad tuning range through the “tuning” of the phase and reflector sections. The laser cavity is formed between the cleaved front surface of the gain section and the rear Bragg reflector. Current injection in the gain section generates photons throughout the spectral gain profile. However, the Bragg section reflects only those photons, which fall into discrete regions of spectral reflectivity. Lasing will occur at a single frequency, which overlaps a discrete reflective region of the Bragg reflector and a cavity mode, resulting in constructive interference. Current injection into the Bragg section alters its refractive index, spectrally shifting the discrete regions of reflectivity. Additionally, current injection into the phase section alters the effective length of the laser cavity defining the mode supporting laser action. Thus, careful control of the reflector and phase currents can result in large mode-hop free tuning ranges.

The tuning behavior of a DBR laser is shown schematically in FIG. 2. According to ADC/Altitun's latest literature, the overall laser tuning range (δλ) is approximately 7.6 nm, as shown in the top portion. For illustrative purposes, only four mode hops are presented. As described above, to achieve consistent 150 MHz steps (δv), a reflector current change is necessary. A phase current change may also be necessary. Additionally, the phase current may need to increase or decrease to maintain a smooth transition to the adjacent wavelength.

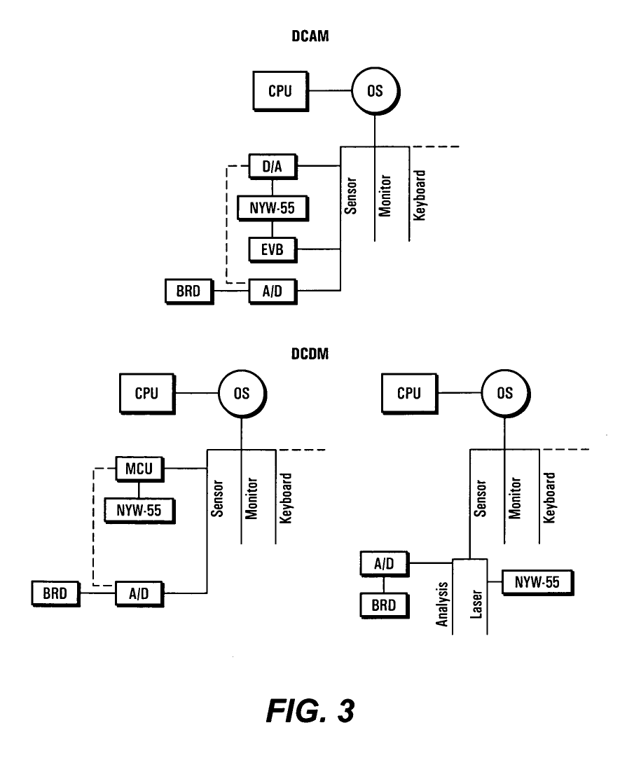

Referring now to FIG. 3, the presence of an analog or digital interface presents multiple options to consider for laser control. FIG. 3 illustrates three digital control strategies available for the laser. Digital control with analog modulation (DCAM) is shown on top. In the bottom of the figure, digital control with digital modulation (DCDM) is shown. In each case, control of the laser temperature and power levels is performed using digital arguments sent to the board. The operating system manages a sensor thread (a program operating in Windows), which exchanges and operates on data from the laser either directly or indirectly. In the top of FIG. 3, wavelength modulation is performed in an analog fashion by sending voltage signals directly to the pin inputs on the NYW 55 PC board. The EVB is a serial interface that sends instructions and receives data regarding the laser temperature and power levels. A dashed line represents a synchronization line between the data acquisition system (AID) and the laser. In the bottom of FIG. 3, modulation of the laser wavelength is performed in a digital fashion (DCDM). The left configuration depicts a microcontroller (MCU) that sends commands to control the laser wavelength in addition to temperature and power monitoring. In turn, the MCU is monitored through a standard RS232 serial port. In the third option, shown on the right, the sensor thread is parallelized by the operating system and commands to the laser and data acquisition system are handled using a parallel port and serial port (respectively) on the CPU bus.

Of the three control strategies illustrated, the analog modulation and the MCU control options are preferred. The CPU-controlled option suffers from synchronization issues between the A/D and the NYW-55 that may be problematic through the operating system, due to uncontrollable interrupt calls to the monitor, hard drive, etc. In the remaining strategies, synchronization signals are routed directly between a dedicated microprocessor or a dedicated digital-to-analog converter.

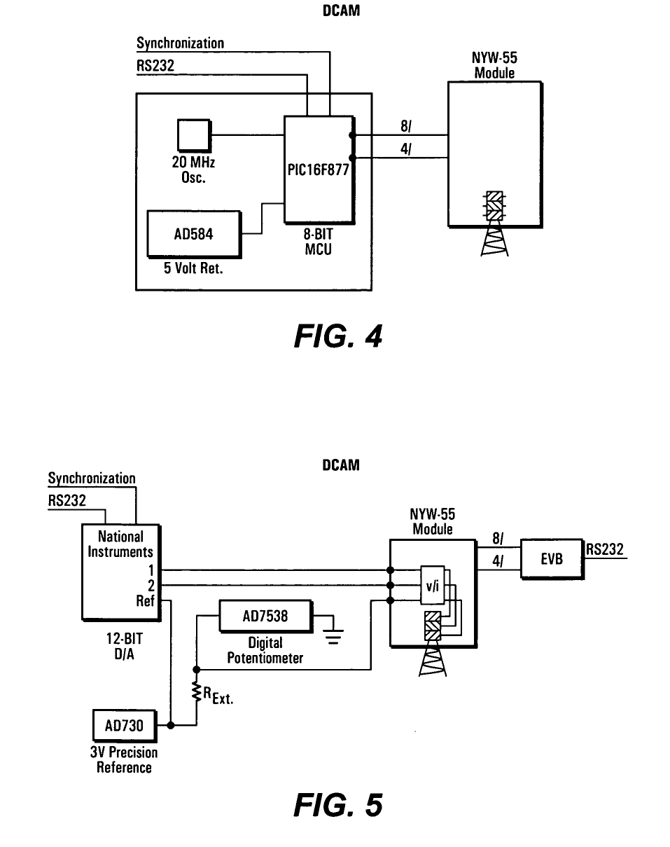

The details of the DCDM strategy using a microprocessor are illustrated in FIG. 4. In this configuration, two sub-boards are to be assembled on one PC board. The sub-board to the left holds an 8-bit microprocessor from Microchip Technology. This RISC microprocessor was selected for its large on-board memory (256 KB) and the minimal need for external components. The only components required are a 5-V reference and a 20-MHz oscillator. The oscillator could be a separate component, or the reference clock from the analog-to-digital converter recording the balanced ratiometric detector (BRD) signals. Additionally, the microprocessor is programmed using a standard RS232 serial port.

The details of the DCAM strategy are illustrated in FIG. 5. A 3-V precision reference (AD730) is fed to a 12-bit National Instruments digital-to-analog converter (DAC). The DAC output is then supplied to the voltage input pins on the NYW-55 for independent modulation of the phase- and reflector-section currents. The voltage to set the gain current is held fixed by a DAC current supply (AD75 38) that is configured as a voltage divider. The external resistance (RExt.) is actually on the AD7538 chip, thus preserving the low-temperature sensitivity (6 ppm/° C.) provided by the laser trimmed thin-film resistors. Digital control of the laser is supplied by a serial to parallel port interface (EVB) that is in turn programmed through a standard RS232 serial port.

Inherent to the digital wavelength control of the NYW-55, is a 200-μs lag between the time a command is sent to change a section current and the current change (also a change in spectral output). Three sequential laser sweeps across the three resonant transitions for the example of CO and H₂O monitoring (one CO and two H₂O lines) would take a minimum of 60 ms. Additional time may be required in the event phase- and reflector-section current adjustments are needed. These would have to be implemented in series. The maximum sweep rate translates to approximately a 16 Hz scan rate. At a minimum, 15 or 16 averages would be required before gas dynamic calculations could be made. As a result, a maximum reporting for water vapor concentration, temperature, and carbon monoxide concentration would be 1 Hz.

By capitalizing on the presence of the on-board voltage to current converters in the NYW-55, a D/A system can be utilized to write voltages directly to the analog inputs to the NYW-55. Additionally, adjustments to the phase and reflector section currents can be made simultaneously. Measurements with laser scans encompassing all three spectral transitions can be made at 100 Hz rates yielding 1 Hz reporting rate with superior signal to noise values in comparison to the digital modulation technique. Thus the preferred mode of control is to modulate the NYW-55 laser using analog outputs from a D/A converter and control the temperature and laser power using a serial digital interface. This choice begins a transition to digital control and minimizes the amount of added components providing an accurate measure of temperature and species concentration for spectroscopy applications.

The control strategy outlined above the ADC NYW-55 laser was specifically targeted due to its perceived level of maturity in multi-section laser technology. However, other manufacturers of the multi-section laser, such as Agility Communication, Inc. (Santa Barbara, Calif.), offer multi-section devices and, as with ADC, their market is currently the telecommunications industry for DWDM applications. The basic architecture of the multi-section lasers are the same.

Finally, the alignment of the multi-section lasers with the ITU-GRID provides compatibility with Erbium Doped fiber amplifiers. Therefore, in applications that require high laser powers, e.g., high particle density streams, the combination of the multi-section laser with EDFA's can provide not only user selectable tunable device but also user selectable or process dictated laser power control. Von Drasek, et al., MULTI-FUNCTIONAL INDUSTRIAL COMBUSTION PROCESS MONITORING WITH TUNABLE DIODE LASERS, Proceedings of SPIE, Vol. 4201 (2000).

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for wavelength tuning control for multi-section diode lasers comprising, in combination:
tuning the laser by spectrally scanning the laser across selected resonant transitions;
determining a substantially mode-hop free tuning range;
generating a synchronization signal;
routing the synchronization signal to a data acquisition system; and
determining the concentration of desired species in a sample to be monitored.

2. A method as described in claim 1, wherein the selected resonant transitions are within the c-band range.

3. A method as described in claim 1, wherein the selected resonant transitions are within the 1-band range.

4. A method as described in claim 1, further comprising sweeping the laser (Δv) approximately 0.5 cm⁻¹ (15 GHz) across each transition.

5. A method as described in claim 4, wherein each sweep comprises small spectral-frequency steps (δv) where δv is about 150 MHz.

6. A method as described in claim 4, further comprising conducting a plurality of sweeps sequentially over a time interval of 10 ms, and repeating the sweeps at a range of between about 100 Hz and about 1000 Hz.
